(19) United States
(12) Patent Application Publication
(10) Pub. No.: US 2021/0172552 A1
(43) Pub. Date: Jun. 10, 2021

(54) Anti-Rotation Locking Mechanism and System

(71) Applicant: JDR Cable Systems Ltd, Littleport, Ely, Cambridgeshire (GB)

(72) Inventors: Philip Allan Ward, Littleport (GB); Archibald Simon Reid, Cambridge (GB)

(21) Appl. No.: 16/771,028

(22) PCT Filed: Dec. 7, 2018
(86) PCT No.: PCT/GB2018/053570

§ 371 Date: Jun. 9, 2020

(30) Foreign Application Priority Data
Dec. 9, 2017 (GB) 1720555.0

(51) Int. Cl. F16L 33/207

(52) U.S. Cl. CPC F16L 33/2076

(57) ABSTRACT

The invention relates to a fitting provided on the end of a pressurized hose or pipe. The invention provides a fitting having a spigot and a ferrule part in which opposing recess and projecting parts are provided to engage each other and prevent the two parts unwinding from each other.

### CROSS-REFERENCE TO RELATED APPLICATIONS

The present application claims priority to PCT International patent Application No. PCT/GB2018/053570, filed Dec. 7, 2018 and Great Britain Patent Application No. 1720555.0 filed on Dec. 9, 2017, the disclosure of which are incorporated herein by reference.

### STATEMENT RE: FEDERALLY SPONSORED RESEARCH/DEVELOPMENT

Not Applicable

### BACKGROUND

The present invention relates to a hose fitting and in particular to a fitting which is arranged to prevent rotation of the respective parts of the fitting.

Conduits, particularly flexible conduits, such as hoses, tubes or pipes (referred to herein as hoses) which are used to carry pressurized fluids (such as air, liquid, hydraulic fluid, cement, fluidized solids, etc.), are generally terminated in some kind of fitting to allow the hose or cable to be removably connected to other elements. Due to the flexible nature of a hose or a pipe, the material used tends to be soft and flexible and so it can be difficult to provide a removable hose without providing a fitting on the end of the hose or pipe which is firmly connected to the hose but also capable of being attached to other elements. Normally, the fitting will be made of rigid material such as metal or some other rigid material to allow it to be connected to other devices securely.

FIG. 1 shows a cross section of a typical fitting. The fitting comprises two main parts, a ferrule 2 and a spigot 3. The ferrule 2 has a generally cylindrical shape. The outer wall 21 defines an inner recess 22 into which the end of the hose to be connected can be inserted. The inner wall of the ferrule may be provided with some kind of surface discontinuity 23 such as teeth or castellations which can be used to help to engage the hose once inserted. The other end of the ferrule 2 includes a portion having an internal thread 24 into which the spigot 3 can be screwed. This discontinuity helps to form a good seal between the hose and the spigot. It also helps the hose to engage the spigot to prevent it becoming detached.

As can be seen in FIG. 1, the spigot is also generally cylindrical having an inner passageway 31 through which the pressurized fluid can pass. The middle portion of the spigot 3 includes an outer threaded section 34 which is arranged to engage the inner thread 24 on the ferrule 2. As shown in FIG. 1, the spigot is screwed into the ferrule such that a hose engaging portion 32 of the spigot body extends from the middle portion along the center of the inner recess 22 of the ferrule to an end near the end of the ferrule 2. The end of the spigot may project beyond the end of the ferrule body of may remain inside the end of the ferrule. The region between the outer part of the hose engaging portion 32 and the inner wall of the recess 22 defines an annular chamber into which the hose is inserted.

In order to assemble the fitting, a hose 1 is inserted into the ferrule such that the hose engaging portion 32 of the spigot 3 passes into the center of the hose. The outer walls of the hose engaging portion 32 may also include a discontinuous surface, e.g. having a surface with teeth (or castellations) 33 as shown in FIGS. 1 and 3, may engage the inner wall of the hose 1. The teeth have a similar function to that described above, by helping to form a good seal between the outer part of the hose and the ferrule and also hold the hose within the ferrule. Once the hose is fully inserted into the ferrule, the teeth 23 and 33 engage the inner and outer surfaces of the hose to resist removal of the hose from the fitting. The outer surface of the ferrule may be further machined or swaged to compressed or deform the ferrule, to increase the engagement of the teeth 23, 33 with the hose to further reinforce the strength of the attachment of the fitting to the hose.

As shown in FIG. 1, the spigot 3 may be provided with a collar 35 having a face which engages with an end face of an abutment shoulder 9 of the ferrule as the spigot is screwed into the ferrule. The ferrule may be provided with spanner flats 26 and the spigot may also be provided with similar spanner flats 36 to allow tightening of the spigot into the ferrule.

In this way, the hose can be firmly and reliably attached to the ferrule which is tightened to the spigot to prepare a complete fitting.

The above arrangement shows one type of typical fitting (generally known as an autoclave or Butech fitting) but other fitting arrangements such as JIC (Joint Industry Council) type or an M type fitting may be used as well as other types of fitting. The assembled fitting may then be used to connect the end of the hose to other devices or hoses to provide a connection for passage of pressurized fluid.

In general, such fittings provide an effective and reliable method of connecting a hose to another device. However, when a hose is filled with fluid and the fluid is then pressurized, the pressure typically generates a torque within the hose. This torque tends to straighten out any twists in the hose. Such hoses may be used alone and simply laid on the floor. They may also be placed in some kind of carrying system or rack or they may be incorporated into other cable systems such as an umbilical bundle which may include several hoses and cables. In these situations, the positioning and manufacture of the hose may result in a significant amount of twisting. In particular, the way of laying up the hose in a cable may introduce significant twist to the hose. When the hose is pressurized this would tend to lead the hose to straighten out. This can result in torque in the hose which can be transferred towards the ends of the cable where hose emerges. The torque will be passed to the end of the hose where the fitting is provided which may actually cause the fitting to rotate unless it is restrained by the device it is attached to. As the pressure in the hose increases, the torque and the potential amount of rotation may become significant. With increasing pressures and larger bore cables being used, this is increasingly becoming a significant factor in the use of pressurized hoses and the like.

Where the fitting is inserted into another device, the spigot may be held firmly in place, but the torque produced in the hose will generally be transferred to the ferrule. This can generate a significant torque between the ferrule and the spigot which may actually loosen the ferrule from the spigot and begin to unwind it off the thread 34 described above. If the pressure is significant enough and the twist in the hose significant enough, then the untwisting effect may be sufficient to cause the ferrule to detach completely from the spigot, depending on the amount of twist induced and the length of the thread. Whilst that is clearly undesirable, even a partial unwinding of the ferrule may lead to damage to and failure of the seal between the hose and the spigot/ferrule. Such damage may result in leakage and/or failure to achieve pressure. This could lead to failure to move a valve being driven by the hose pressure or a failure to inject pressurized chemicals being fed by the hose which is also highly undesirable and detrimental to the reliable operation of the hose. The damage to the seal may result in a hose burst which could lead to a more critical type of failure such as leakage of pressurized fluid. Complete separation of the ferrule from the spigot may result in complete failure of the fitting leading to a number of undesirable consequences such as damage to equipment and the possibility of injury to operators.

It is therefore desirable to ensure that the spigot and ferrule are firmly held together—the traditional method of simply tightening the threaded spigot into the ferrules such that the engaging faces lock together is potentially insufficient due to the higher torques generated in higher pressure applications. In order to overcome this problem, it might be possible to weld the two parts together to form a more permanent connection between the spigot and ferrule. However, this is generally undesirable for a number of reasons. The need to weld the two parts together imposes a limitation on the materials that can be used for both the spigot and the ferrule. For example, not all high-grade materials are easily welded and so less desirable or more expensive materials may have to be used to allow welding to be used. The process of welding can be a fairly aggressive process and can lead to distortion of the components and potentially damage the spigot, ferrule or hose during assembly. The heat used to achieve welding generally affects the properties of the material around the welding zone which can reduce the overall strength of the material, which may require the parts to be made larger or more complex. Furthermore, the resistance of the parts to corrosion can be degraded in the heat affected zone around the weld. This again may require further steps to be taken to mitigate the reduction in the corrosion resistance of the parts.

Alternatively, rather than welding the parts together, other mechanical locking devices may be used. This would typically involve applying a third element to the fitting to lock the two components together. However, this has drawbacks and such a third part would typically encapsulate the end of the fitting and would generally make the fitting bulkier and more complex. This can make the fitting more cumbersome and difficult to align, and also more difficult to use in practice.

Mechanical joining devices may also induce crevice corrosion which would again require further steps to be taken to mitigate the potentially corrosive effects. The increased bulk of the third component would also require greater space to be provided between connections further complicating the connection assembly. This would also tend to increase the length of the fitting and have other physically effects such as increasing the weight and cost.

Therefore there is a desire to provide an improved fitting which is resistant to the component parts rotating relative to each other without unnecessarily comprising the structure of the fitting or overcomplicating the design of the fitting itself, or components to which the fitting is to be connected.

### SUMMARY

According to the present invention there is provided a fitting for attachment to a hose, the fitting comprising: a spigot having a hose engaging portion and a threaded portion; a ferrule having a hose engaging portion and a threaded portion for screwing the spigot and ferrule together; and a lock arrangement for preventing relative rotation of the spigot and ferrule in at least one direction, the lock arrangement comprising: a recess formed in a surface of one of the spigot and the ferrule; and an engaging protrusion projecting from an opposing surface of the body of the other of the spigot and the ferrule and projecting into the recess, wherein said surface and said opposing surface are arranged such that relative rotation of the spigot and ferrule causes translation of said surface relative to said opposing surface such that the engaging protrusion engages the side of the recess for preventing rotation.

This arrangement provides a comparatively simple solution to the potential problem of the spigot and ferrule unwinding from each other without the need for complex additional elements or substantial reworking of the spigot and ferrule.

Preferably, the recess is formed on an outer circumferential surface of a cylindrical portion of the spigot and the ferrule has an axially projecting collar portion from which the engaging protrusion projects radially inwardly, wherein the collar portion defines a cylindrical space in which the cylindrical portion of the spigot is positioned.

This allows the simple collar portion extension on the ferrule to be provided which encompasses the portion of the spigot having the recess. The engaging protrusion can then be configured to lie in the recess by externally deforming the ferrule to push the protrusion into the recess such that any relative rotation is restricted.

Alternatively, the recess may be formed on an outer circumferential surface of a cylindrical portion of the ferrule with the spigot having an axially projecting collar portion from which the engaging protrusion projects radially inwardly. The collar portion would define a cylindrical space in which the cylindrical portion of the ferrule is positioned.

This also allows the simple collar portion extension on the spigot to be provided which encompasses the portion of the ferrule having the recess. In a similar manner to that described above, the engaging protrusion can be configured to lie in the recess by externally deforming the collar portion of the spigot to push the protrusion into the recess in the ferrule to resist relative rotation of the spigot and ferrule.

In a further option, the surface and the opposing surface may be opposing axially facing surfaces of the ferrule and the spigot. In this configuration, the two faces arranged perpendicular to the axial or longitudinal axis of the spigot and ferrule can be configured so that the protrusion extends in an axial direction to effectively prevent relative rotation of those faces and hence the spigot and ferrule. This allows the displacement of the material forming the protrusion to be done axially rather than radially.

The surface and the recess may be provided on the spigot, with the opposing surface and the engaging protrusion provided on the ferrule. Alternatively, the surface and the recess may be provided on the ferrule, with the opposing surface and the engaging protrusion provided on the spigot.

In this way, either the spigot or the ferrule may carry the protrusion allowing flexibility in the design of the fitting.

The projecting portion can be formed from material displaced from the rest of said body. For example, where the protrusion is simply a part of the body which is pressed from one side so that material is displaced on the other side of the body to form the projecting portion.

Alternatively, the projecting portion may be a deformed or deflected part of the body, for example where a projecting end of a piece of the body is deflected or bent out of alignment with the rest of the body to enter into the recess.

Where the projecting portion is a portion of the body deformed or deflected to extend away from the rest of the body to lie in said recess, the portion is preferably arranged to have an engaging edge on the deflected portion for engaging a corresponding edge of the recess. This may be done by cutting the body to form an edge prior to deflecting it or by using an existing edge of the body and deflecting the portion so that the edge is positioned in the recess to engage the opposing corresponding edge of the recess.

The present invention also provides a method of constructing a fitting for attachment to a hose, the fitting comprising a spigot having a hose engaging portion and a threaded portion, and a ferrule having a hose engaging portion and a threaded portion for screwing the spigot and ferrule together, wherein the method comprises: forming a recess in a surface of one of the spigot and the ferrule; screwing the threaded portion of the spigot into the threaded portion of the ferrule to join the ferrule and spigot; driving a staking tool into a part of the body of the other of the spigot and the ferrule which does not have the recess, at a part of the body adjacent to the recess, to displace a portion of the body to form an engaging protrusion which projects into the recess to resist translation of a surface of the body opposing the recess relative to said surface in which the recess is provided and thereby resist relative rotation of the spigot and ferrule.

The recess may be formed on an outer circumferential surface of a cylindrical portion of the spigot and the ferrule provided with an axially projecting collar portion, wherein the collar portion defines a cylindrical space in which the cylindrical portion is positioned, and said staking tool is driven radially into the collar portion to displace the engaging protrusion radially inwards from the collar portion to project into the recess.

Alternatively, the recess may be formed on an outer circumferential surface of a cylindrical portion of the ferrule and the spigot provided with an axially projecting collar portion, wherein the collar portion defines a cylindrical space in which the cylindrical portion is positioned, and said staking tool is driven radially into the collar portion to displace the engaging protrusion radially inwards from the collar portion to project into the recess.

These arrangements allow the spigot and ferrule to be prepared in a fairly standard way but then locked against relative rotation by the simple use of the staking tool or similar tool for introducing the deformation for engaging the recess.

The surface of one of the spigot and the ferrule and the surface of the body opposing the recess may be arranged to be opposing axially facing surfaces of the ferrule and the spigot, with the staking tool driven axially into the part of the body, to displace the engaging protrusion axially into the recess.

Alternatively, said surface of one of the spigot and the ferrule and said recess are provided on the spigot, and the surface of the body opposing the recess and the engaging protrusion are provided on the ferrule.

The surface of one of the spigot and the ferrule and the recess may be provided on the ferrule, with the surface of the body opposing the recess and the engaging protrusion provided on the spigot.

The part of the body may be a projection extending from the body such that a portion of said projection extends away from the body and wherein the driving tool deflects the portion of the projection to form the engaging protrusion.

The part of the body preferably has an engaging edge and said part of the body is deflected into said recess such that said engaging edge lies adjacent to a corresponding edge of said recess.

The method preferably further comprises forming the projection by providing a slit separating part of said projection from said body. This allows the deformation process to more cleanly deflect the separated part of the body from the rest of the body. In other words, by cutting or otherwise separating the projection form the rest of the body, the projection can be more easily deflected away from the rest of the body and may also have a cleaner end surface, i.e., where an end face can engage a corresponding face for engaging the recess to resist rotation.

The slit may be formed e.g., by cutting, once in position, or prefabricating the slit before assembly. There are advantages to preparing the slit once the fitting is assembled so that accurate alignment is achieved but this may also be achieved by accurate manufacture of the fitting so that once the spigot and ferrule are tightened, the recess is accurately positioned adjacent to the slit ready for deflection.

Preferably, the slit is formed on two or more sides of the projection. In this way, a tab can be formed which is separated from the rest of the body on two or more sides forming a tongue like extension or tab which is more easily and accurately manipulated or bent into position in the recess.

### BRIEF DESCRIPTION OF THE DRAWINGS

The invention will now be described in further detail by reference to the drawings in which:

FIG. 1 shows a cross-sectional view through a typical two-part fitting;

FIG. 2 shows a perspective view of the fitting of FIG. 1;

FIG. 3 shows an enlarged cross-sectional view of the fitting of FIG. 1;

FIG. 4 shows a partial perspective view of a spigot according to the present invention;

FIG. 5 shows a partial perspective view of the ferrule of the present invention;

FIG. 6 shows a partial cross-section through the fitting;

FIG. 7 shows a perspective view of the fitting attached to a hose;

FIG. 8 shows a close-up view of the end of the fitting shown in FIG. 7;

FIG. 9 shows an end view of the fitting showing the forces applied to the ferrule during construction of the fitting;

FIGS. 10a to 10c show examples of some of the different possible notch shapes;

FIG. 11a shows the fitting of FIG. 9 showing the direction of movement of the spigot that is resisted by engagement with the ferrule;

FIG. 11b similarly shows the fitting of FIG. 9 showing the direction of movement of the ferrule that is resisted by engagement with the spigot;

FIG. 12 shows an example of a fitting in which cutting is used;

FIG. 13 shows a fitting without cutting;

FIG. 14 shows a perspective view of an alternative fitting construction;

FIG. 15 shows a top view of the alternative fitting;

FIG. 16 shows a cross sectional view through the alternative fitting along A-A;

FIG. 17 shows a cross sectional view through the alternative fitting along B-B;

FIG. 18 shows a perspective view of a further fitting construction;

FIG. 19 shows a view of the further fitting from above;

FIG. 20 shows an end view of the further fitting;

FIG. 21 shows a side view of the further fitting; and

FIG. 22 shows a cross sectional view through the further fitting along A-A.

### DESCRIPTION

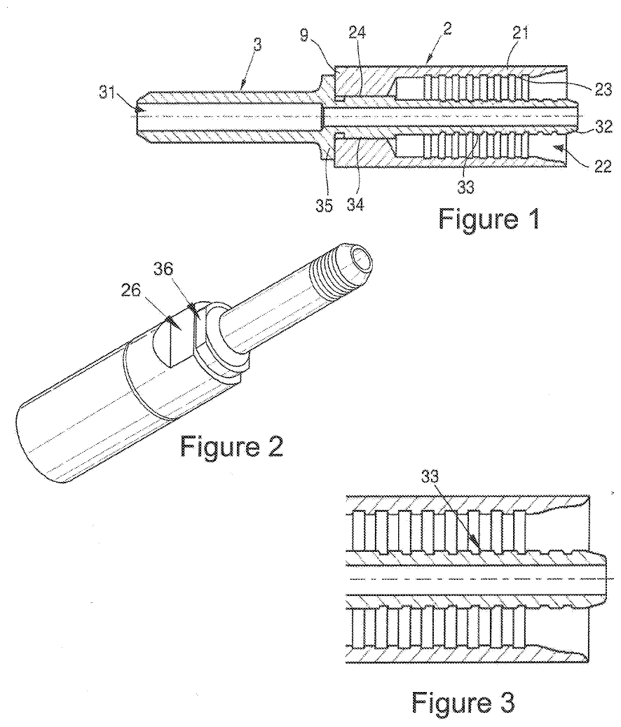

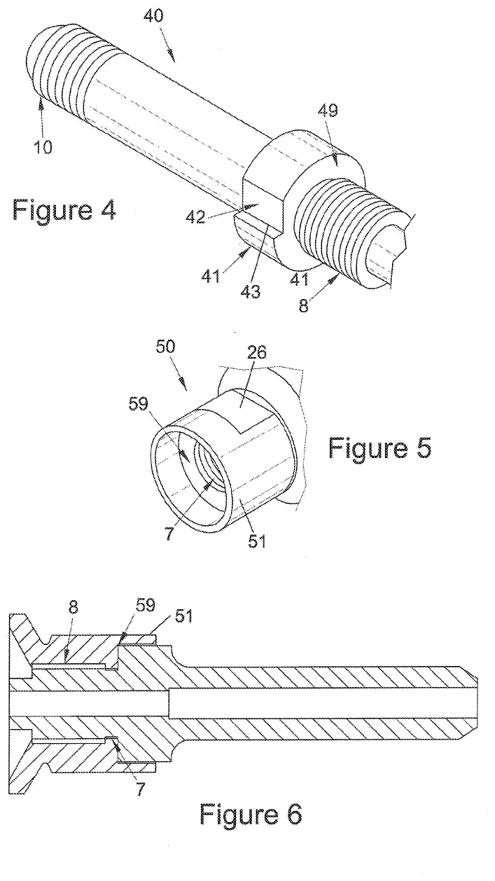

FIG. 4 shows a partial view of a modified spigot 40. The spigot 40 is similar to the spigot 2 shown in FIG. 1 but additionally includes a notch 42 formed in the collar 41. Adjacent to the collar 41, the spigot is provided with a portion with an external thread 8 similar to the external thread 34 shown in FIG. 1. This thread 8 is used to engage a ferrule for attaching it to the spigot. Extending from the threaded portion is a further tubular hose engaging portion (not shown in full) which passes into the centre of the hose when the hose is inserted into the ferrule. At the other side of the collar 41, the spigot 40 extends to form a connection interface 10 for connecting the fitting to other devices.

As shown in FIG. 4, the notch 42 may reduce in depth from one side to the other so that a simple step portion is formed with an end face 43 on one side, whereas the depth reduces to zero on the other side. However, the notch may take other forms. For example, the notch may be formed with a substantially constant depth such that at both sides of the notch a side face is formed rather than just at one side as shown in FIG. 4. As will be explained further below, the main feature of the notch is to provide an engaging surface formed by the end face 43, to prevent rotation of the ferrule relative to the spigot.

FIG. 5 shows a modified ferrule 50. Only the end portion of the ferrule 50 is shown, where it engages the spigot 40. The ferrule 50 is similar to the ferrule 2 shown in FIG. 1 but includes an extended collar portion 51 which projects axially from the end of the abutment shoulder 59. The ferrule also includes an internal thread 7 similar to the thread 24 shown in FIG. 1. The ferrule may also include spanner flats 26.

In order to assemble the fitting, the spigot is inserted into the ferrule. The thread 8 is brought up to the internal thread 7 on the ferrule and the spigot is then screwed into the ferrule. As the spigot is wound into the ferrule, the collar 41 passes into the internal space enclosed by the collar 51, at least partially. Eventually, as the spigot is wound completely into the ferrule, the abutment shoulder 49 on the end face of the collar 41 engages the abutment shoulder 59 on the end face of the ferrule within the collar 51. The engagement of the abutment shoulders 49 and 59 prevents further movement of the spigot into the ferrule and tightly engages the spigot 40 to the ferrule 50. This arrangement is shown in FIG. 6 where the spigot is fully inserted into the ferrule.

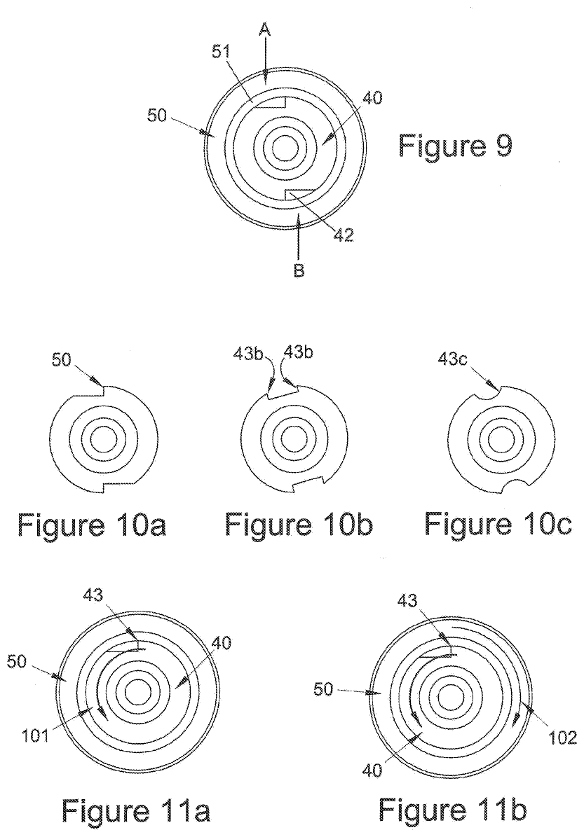

Once the spigot has been received in the ferrule, a portion of the ferrule is deformed to cause a portion of the collar to be driven into the recess defined by the notch 42. FIG. 9 shows an end view of the fitting. The spigot 40 can be seen in the center with the notch 42 visible. Force is applied to the collar 51 at the point indicated by the arrows labelled A and B. The force is applied to the collar by a pointed object such as a spike or stake. The application of this staking force to the collar 51 causes the collar to be deformed and part of it pressed into the recess defined by the notch 42. Once the staking process has been completed, the force is removed and the fitting is completed.

As shown in FIG. 11a, if the ferrule is held in place and it is attempted to rotate the spigot, the end face 43 of the notch will engage the deformed portion of the collar preventing rotation of the spigot in the direction shown by arrow 101. Similarly, in FIG. 11b, if the spigot is held in place and it is attempted to rotate the ferrule, the deformed portion of the ferrule will engage the face 43 of the notch preventing rotation of the ferrule in the direction 102 show in FIG. 11b. In other words, any attempt to unwind the ferrule from the spigot will be resisted by the engagement of the deformed part of the collar with the face of the notch 43.

FIG. 10a shows and end view of a spigot similar to that in FIG. 9 showing a notch with a single face 43. FIG. 10b shows a modified version in which the notch is symmetrical about a radial line and so has two end faces 43b. FIG. 10c shows a further alternative where a curved recess is provided with a less defined edge 43c. However, the recess still provides a sufficient depth to allow the ferrule to be displaced into it, such that the displaced portion can engage the edge 43c of the recess to prevent relative rotation.

As shown in FIGS. 9 to 11, the spigot preferably includes two notches and the collar is deformed in two corresponding places to provide two points of contact and engagement to prevent rotation of the spigot relative to the ferrule. However, this may be achieved by providing a single notch and a single point of deformation on the collar, or multiple notches with multiple corresponding notch points on the ferrule.

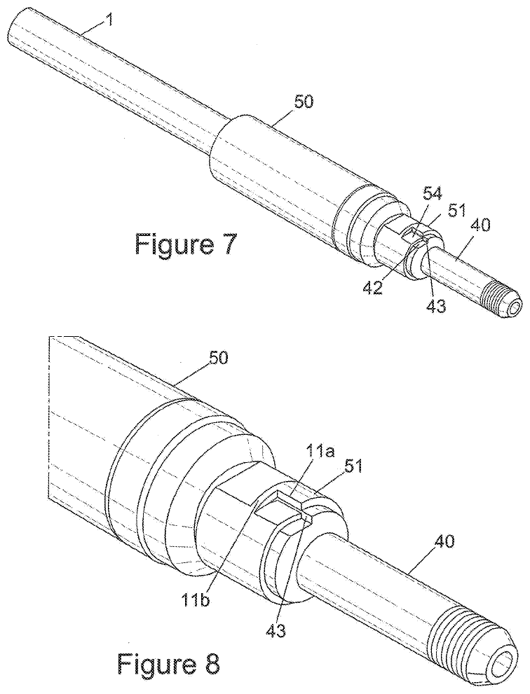

FIG. 7 shows a completed fitting with the collar 51 including the deformed portion 54 which has been forced down into the notch 42. FIG. 8 has a closer view of the end of the fitting of FIG. 7. As can be seen in FIG. 8, to assist with the formation of the deformed portion, the ferrule may be provided with a preparatory staking cut 11a and may further include a secondary staking cut 11b. The staking cut 11a can be formed prior to insertion of the spigot into the ferrule typically during manufacture of the ferrule although it may be formed once the spigot is inserted into the ferrule which can help to ensure that the cut aligns with the notch accurately without requiring onerous manufacturing tolerances. The cuts may be formed by cutting before staking using a cutting tool or they may be formed as part of the staking process using a sharp-edged chisel-like staking tool. This allows the cut to be formed as the staking tool is driven in to displace the deformed portion of the ferrule. However, the cut may be formed with one tool and then the completion of the displacement of the deformed portion may be carried out in a second step using a different tool.

The primary staking cut 11a would be formed as an axially extending cut to the collar. The secondary staking cut 11b may then be formed in a circumferential direction to effectively define a tab portion of the collar which is connected to the ferrule at only one end of the tab. With this arrangement, when the stake is applied to the tab, it can be easily bent down into the notch formed in the spigot 40. This also provides a sharp end face on the end of the tab which will effectively engage the end face 43 of the notch. Even without the secondary staking cut 11b, the provision of the primary staking cut 11a allows the deformed portion of the ferrule to be bent downwards so that the end face of the deformed portion nearest the front edge of the collar forms a significant overlap with the end face 43 of the notch.

Other cuts may be used to achieve a similar effect. For example, the primary staking cut 11a may be provided along with a second primary staking cut in parallel with the primary staking cut 11a. The two parallel cuts would then define a tab extending from the ferrule along the longitudinal axis of the fitting. When the stake is applied to the tab, the leading edge of the tab would be bent downwards into the notch so that the side edge of the tab would form an

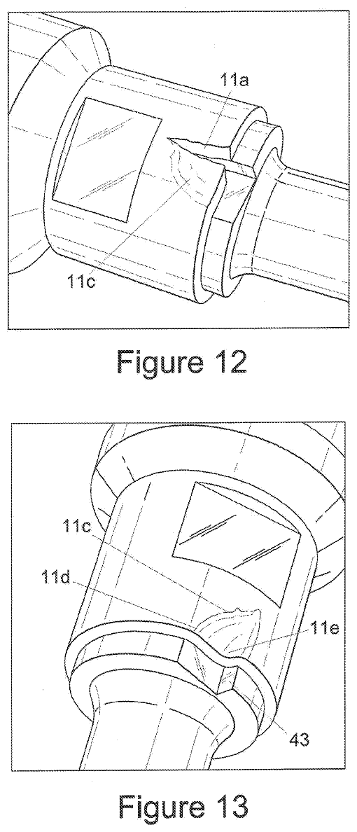

FIG. 12 shows an example of a fitting in which a primary staking cut 11a has been made. As the stake is applied to the collar, the force deforms the collar, as described above. The part of the collar adjacent to the primary staking cut 11a is easily displaced downward into the notch 42. This forms a staking fold 11e where the collar has bent away from its initial position along the fold line shown.

In an alternative embodiment, the staking cuts may be omitted from the ferrule.

However, the same blocking effect can be achieved by simply deforming the collar portion. FIG. 13 shows an example of such an arrangement in which the stake has been applied to the collar causing the collar to deform. The deformed section of the collar is pressed into the space defined by the notch 42 with staking folds 11c, 11d and 11e being formed around the point of application of the stake to the collar, where the collar material has been bent and deformed into the recess of the notch 42. The deformed material is pressed into the notch sufficiently to form a protrusion which can engage with the face 43 of the notch to prevent rotation of the spigot relative to the ferrule.

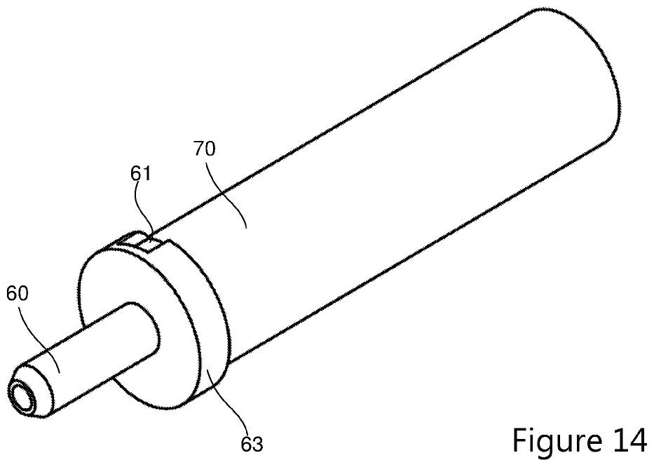

In the above embodiment, the collar is deformed by pushing a part of it radially inwards to engage the notch. However other arrangements may be used to achieve a similar locking effect. FIG. 14 shows a modified fitting with a different locking arrangement. Instead of the ferrule having a collar which is deformed, the ferrule 70 ends with the abutment face 72. The outer circumferential edge is provided with diametrically arranged notches 71 at the top and bottom of the ferrule 70.

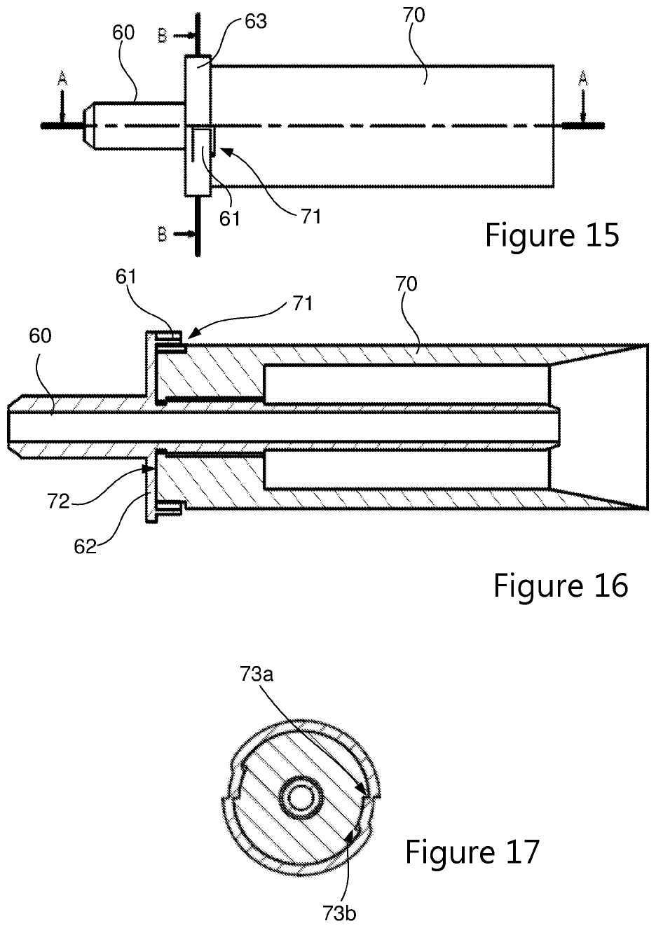

The notches formed in the ferrule surface may be similar to the notches formed in the spigot, as described above. The notch 71 shown in FIGS. 14 to 17 is of substantially constant depth such that two end faces 73a, 73b are formed, similar to the notch shown in FIG. 10b. However, they may have other shapes such as those shown in FIGS. 10a and 10c, or other shapes which allow the protrusion to engage the recessed part of the notch.

The spigot is also modified compared to the arrangement described above. The collar 62 may be slightly narrower than the collar 41, although this is not essential, and it now includes an extended collar portion 63 which extends axially from the outer edge of the collar 62 to form a cylindrical portion. The inner diameter of the cylindrical collar portion 63 is such as to allow the end of the ferrule is pass within it.

When the fitting is constructed, the spigot is inserted into the ferrule so that the respective threaded portions engage, as described above. The spigot is then wound into the ferrule in a similar manner. As the spigot is wound in, the end of the ferrule having the abutment face 72 passes into the space within the cylindrical extended collar portion 63. Eventually, the abutment face 72 meets the edge of the collar 62 preventing further rotation of the spigot into the ferrule. At this stage, a portion of the end of the ferrule 70 lies within the space defined by the extended collar portion 63.

In a similar manner to that described previously, the extended collar portion 63 can be deformed by applying a staking tool or the like to the outer surface of the extended collar portion 63 to deform a portion of it which is forced into the notch 71 in the ferrule. As before, the extended collar portion 63 may be pre-prepared by forming staking cuts in the collar to define a tab 61 suitable for deformation. The staking cuts may be made in one or more places to define different configurations of tab, similar to those described above. In the arrangement shown, a pair of staking cuts are made, one in an axial direction and a second in a circumferential direction to define a tab 61 which extends in a circumferential direction.

The arrangement shown has a pair of notches 71 and a pair of tabs 61 arranged opposite each other. However, a single notch and tab may be used or multiple notch and tabs may be arranged around the circumference of the fitting.

As described above, the insertion of the tab or deformed part of the spigot collar 63 into the notch means that it can engage the end faces 73a, 73b of the notch to prevent rotation of the spigot relative to the ferrule. As noted above, the arrangement shown has a fixed depth notch with two end faces 73a, 73b. However, since the design is principally concerned with preventing unwinding of the spigot and the ferrule from each other, only one of the end faces is needed to achieve this. The engagement of the shoulder 62 with the end face 72 prevents further rotation of the spigot in the tightening direction and so the second end face is generally redundant although, in some cases, it may be desired to lock the ferrule and spigot in a position before the face 72 has engaged the shoulder and so the second end face can be used to limit further tightening of the spigot and ferrule together. Other notch shapes can be provided such as the single side face notch shown in the ferrule shown in FIGS. 4 and 8 to 13.

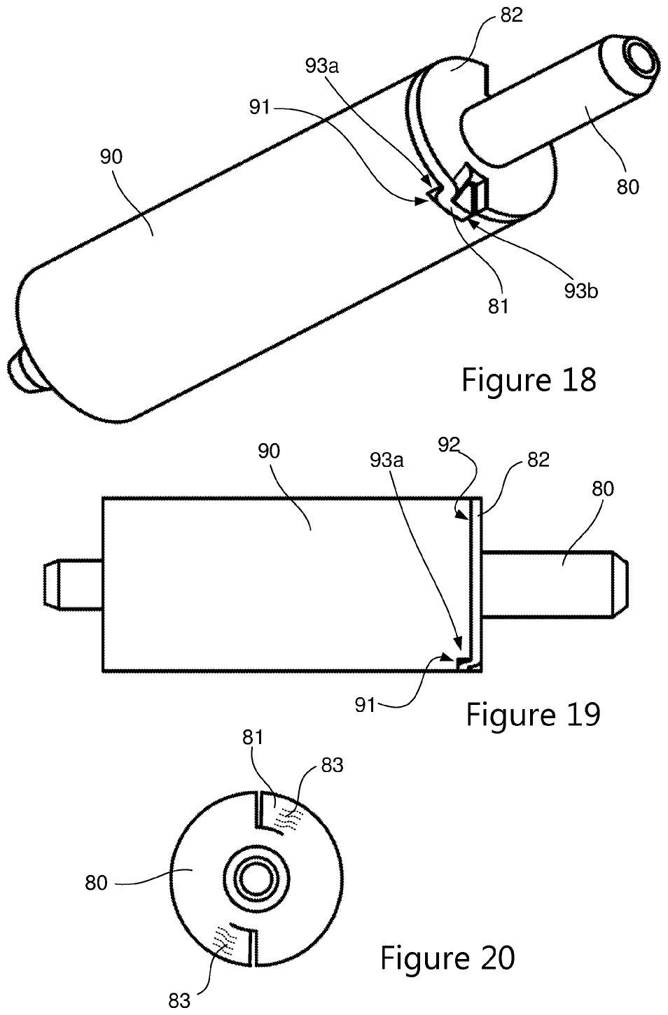

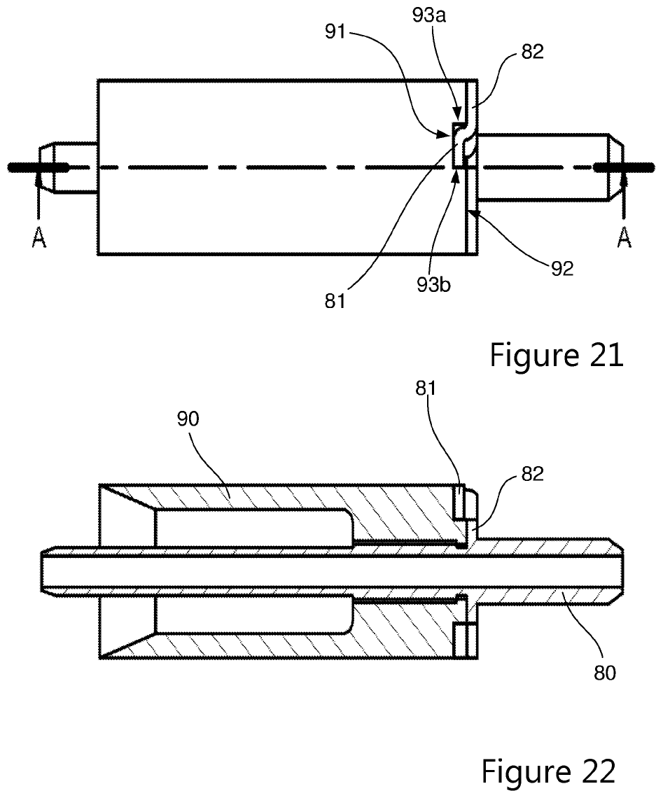

It will be appreciated that the arrangement described above operates in fundamentally the same way with the deformed portion of a collar or tab engaging a respective notch to prevent relative unwinding of the two respective parts. The general principle of deforming a part of one of the spigot of ferrule so that the deformed portion engages a respective recess on the other part to form a type of catch can be applied in other arrangements. A further example is shown in FIGS. 18 to 22 and described below.

In the arrangement shown in FIG. 18, the spigot 80 and ferrule 90 are again slightly different to those above. The spigot is provided with a collar 82 which extends outwardly form the body of the spigot 80. The collar takes the form of a disc as shown. Otherwise, the spigot is similar to the previously described spigots 40, 60.

The ferrule 90 has a cylindrical outer shape which ends in an end face 92. A notch 91 is provided in the end face at each side of the ferrule. The notch is formed into the end face and, in this example also opens out into the outer circumference, although that is not essential. The notch effectively defines a partial segment shaped recess on the end face of the ferrule. Of course other shapes may be used as described above as long as the material displaced into the recess is able to engage the side to prevent relative rotation.

The ferrule and spigot and screwed together, as previously described, until the edge face of the collar 82 engages with the end face 92 of the ferrule, preventing further rotation relative to each other. The collar is then deformed using a staking tool or the like to push part of the collar axially, so that it is forced into the space defined by the notch 91.

As shown in FIG. 16, staking cuts are provided in the collar to separate two sides of a tab 81 from the rest of the collar. This allows the tab portion to be easily deflected axially to enter the notch 91. Once this tab is deformed, any attempt to unscrew the spigot and ferrule will cause the end of the tab 91 to abut against the edge 93b of the notch. FIG. 20 shows how the tab is folded down along a staking fold 83 so that the end lies within the space of the notch 91.

In the example shown in FIGS. 18 to 22, two staking cuts were made prior to deforming the tab to enter into the notch but, as above, these cuts are not essential and simply provide a more reliable better-defined engagement surface. In other arrangements a single cut may be provided, for example a radial cut extending from the outer periphery. Two different cuts may be made, for example a pair of radial cuts could be made to define a tab which extends radially. The cuts are, however, not essential and the staking tool may simply be used to deform the material of the collar 82 so that it protrudes into the recess formed by the notch 91.

As noted above, the above examples provide a number of different ways of achieving the effect of the invention. Other arrangements beyond these examples are possible within the scope of the claims. The precise number of notches are tab or deformed portions is not an essential feature of the invention and a single notch and tab may be used or multiple notches and tabs may be used. They will preferably be arranged evenly around the circumference of the spigot/ferrule to balance and distribute the load placed on them.

Reference to a staking tool and the action of staking in the above is intended to cover the application of force to a part of the fitting using a relatively pointed object to cause deformation of the part of the fitting such that a portion of the fitting is displaced such that it can engage with the recess formed by the notch.

1. A fitting for attachment to a hose, the fitting comprising:
a spigot having a hose engaging portion and a threaded portion;
a ferrule having a hose engaging portion and a threaded portion for screwing the spigot and ferrule together; and
a lock arrangement for preventing relative rotation of the spigot and ferrule in at least one direction, the lock arrangement comprising:
a recess formed in a surface of one of the spigot and the ferrule; and
an engaging protrusion projecting from an opposing surface of the body of the other of the spigot and the ferrule and projecting into the recess, wherein
said surface and said opposing surface are arranged such that relative rotation of the spigot and ferrule causes translation of said surface relative to said opposing surface such that the engaging protrusion engages the side of the recess for preventing rotation.

2. A fitting according to claim 1 wherein the recess is formed on an outer circumferential surface of a cylindrical portion of the spigot and the ferrule has an axially projecting collar portion from which the engaging protrusion projects radially inwardly, wherein the collar portion defines a cylindrical space in which the cylindrical portion of the spigot is positioned.

3. A fitting according to claim 1 wherein the recess is formed on an outer circumferential surface of a cylindrical portion of the ferrule and the spigot has an axially projecting collar portion from which the engaging protrusion projects radially inwardly, wherein the collar portion defines a cylindrical space in which the cylindrical portion of the ferrule is positioned.

4. A fitting according to claim 1 wherein said surface and said opposing surface are opposing axially facing surfaces of the ferrule and the spigot.

5. A fitting according to claim 4 wherein said surface and said recess are provided on said spigot, and said opposing surface and said engaging protrusion are provided on said ferrule.

6. A fitting according to claim 4 wherein said surface and said recess are provided on said ferrule, and said opposing surface and said engaging protrusion are provided on said spigot.

7. A fitting according to claim 1 wherein the projecting portion is formed from material displaced from the rest of said body.

8. A fitting according to claim 7 wherein the projecting portion is a deformed part of the body.

9. A fitting according to claim 7 wherein the projecting portion is a portion of the body extending away from the rest of the body which is deflected to lie in said recess, and wherein the portion has an engaging edge on the deflected portion for engaging a corresponding edge of said recess.

10. A method of constructing a fitting for attachment to a hose, the fitting comprising a spigot having a hose engaging portion and a threaded portion; and a ferrule having a hose engaging portion and a threaded portion for screwing the spigot and ferrule together, the method comprising:
forming a recess in a surface of one of the spigot and the ferrule;
screwing the threaded portion of the spigot into the threaded portion of the ferrule to join the ferrule and spigot;
driving a staking tool into a part of the body of the other of the spigot and the ferrule which does not have the recess, at a part of the body adjacent to the recess, to displace a portion of the body to form an engaging protrusion which projects into the recess to resist translation of a surface of the body opposing the recess relative to said surface in which the recess is provided and thereby resist relative rotation of the spigot and ferrule.

11. A method according to claim 10, wherein the recess is formed on an outer circumferential surface of a cylindrical portion of the spigot and the ferrule has an axially projecting collar portion, and wherein the collar portion defines a cylindrical space in which the cylindrical portion is positioned, wherein said staking tool is driven radially into the collar portion to displace the engaging protrusion radially inwards from the collar portion to project into the recess.

12. A method according to claim 10, wherein the recess is formed on an outer circumferential surface of a cylindrical portion of the ferrule and the spigot has an axially projecting collar portion, and wherein the collar portion defines a cylindrical space in which the cylindrical portion is positioned, wherein said staking tool is driven radially into the collar portion to displace the engaging protrusion radially inwards from the collar portion to project into the recess.

13. A method according to claim 10, wherein said surface and said surface of the body opposing the recess are opposing axially facing surfaces of the ferrule and the spigot, and wherein said staking tool is driven axially into said part of the body to displace the engaging protrusion axially into the recess.

14. A method according to claim 10 wherein said surface and said recess are provided on said spigot, and said surface of the body opposing the recess and said engaging protrusion are provided on said ferrule.

15. A method according to claim 10 wherein said surface and said recess are provided on said ferrule, and said surface of the body opposing the recess and said engaging protrusion are provided on said spigot.

16. A method according to any one of claim 10, wherein said part of the body is a projection extending from the body such that a portion of said projection extends away from the body wherein the driving tool deflects the portion of the projection to form the engaging protrusion.

17. A method according to claim 16, wherein said part of the body has an engaging edge and said part of the body is deflected into said recess such that said engaging edge lies adjacent to a corresponding edge of said recess.

18. A method according to claim 16, wherein said method further comprises forming said projection by providing a slit separating part of said projection from said body.

19. A method according to claim 18, wherein said slit is formed on two or more sides of the projection.

20. A method according to claim 17, wherein said method further comprises forming said projection by providing a slit separating part of said projection from said body.
